(19) United States
(12) Patent Application Publication
(10) Pub. No.: US 2009/0258159 A1
(43) Pub. Date: Oct. 15, 2009

(54) NOVEL TREATMENT FOR MASK SURFACE CHEMICAL REDUCTION

(75) Inventors: Yih-Chen Su, Taichung City (TW); Ting-Hao Hsu, Hsinchu City (TW); Sheng-Chi Chin, Jhubei City (TW); Heng-Jen Lee, Hsinchu County (TW); Hung Chang Hsieh, Hsin-Chu City (TW); Yao-Ching Ku, Hsinchu City (TW)

Correspondence Address: HAYNES AND BOONE, LLP;IP Section, 2323 Victory Avenue, Suite 700, Dallas, TX, 75219, US

(73) Assignee: TAIWAN SEMICONDUCTOR MANUFACTURING COMPANY, LTD., Hsin-Chu (TW)

(21) Appl. No.: 12/100,822

(22) Filed: Apr. 10, 2008

(51) Int. Cl. B08B 6/00; B05D 3/06

(52) U.S. Cl. 427/534; 134/172; 134/1.1

(57) ABSTRACT

A method includes forming an absorption material layer on a mask; applying a plasma treatment to the mask to reduce chemical contaminants after the forming of the absorption material layer; performing a chemical cleaning process of the mask; and performing a gas injection to the mask.

### BACKGROUND

Various mask contaminants, such as chemical contaminants, introduced during the fabrication of a mask are hard to remove. The current cleaning methods do not efficiently remove the mask contaminants and may further cause damage to a mask especially to a patterned absorption layer such as a MoSi or Cr layer formed on the mask.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 illustrates a flow chart of one embodiment of a method for cleaning a mask.

FIG. 2 is an exemplary mask that can be cleaned using the method of FIG. 1.

FIG. 3 illustrates an exemplary system designed for cleaning a mask using the method of FIG. 1.

FIGS. 4 through 7 show various schematic diagrams of mask chemical residue reduction in various embodiments constructed according to aspects of the present disclosure.

### DETAILED DESCRIPTION

It is to understood that the following disclosure provides many different embodiments, or examples, for implementing different features of various embodiments. Specific examples of components and arrangements are described simplistically for purposes of clarity. These are, of course, merely examples and are not intended to be limiting.

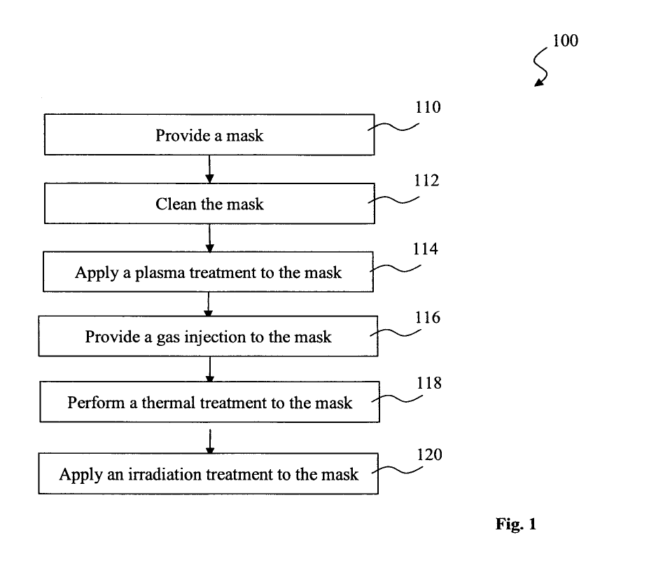

Referring to FIG. 1, a method 100 is used to clean a photomask that can be used to fabricate semiconductor wafers and the like. The photomask is also referred to as a mask or reticle. Even though the mask is employed as an example to illustrate the disclosed method and system, it is not limited to a mask and may be extended to cleaning other substrates having similar contamination issues.

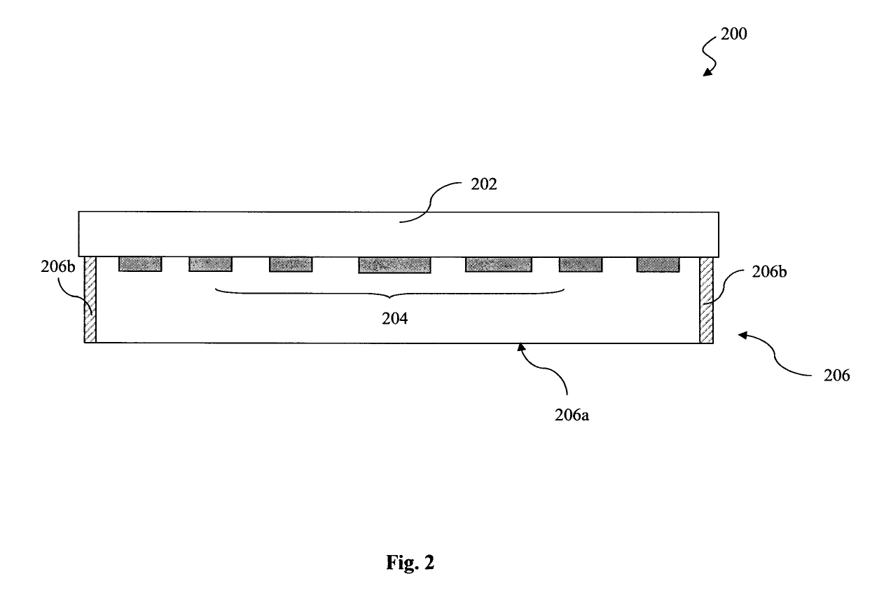

The method 100 begins at step 110 by providing a mask to be cleaned. FIG. 2 illustrates an exemplary mask 200. The mask 200 includes a transparent substrate 202 having fused quartz (SiO₂), calcium fluoride (CaF₂), or other suitable material. The mask further includes an absorption layer 204 formed on the transparent substrate, using chromium (Cr) and/or MoSi. In various embodiments, the absorption layer may alternatively include Cr, MoSi, iron oxide, or an inorganic film made with MoSi, ZrSiO, SiN, MoSiONₓ, and/or TiN. The absorption layer may have a multilayer structure. For example, the absorption layer may include a layer of Cr film and a layer of MoSi film. In another example, the absorption layer may further include an anti-reflective coating (ARC) layer. The mask may further include patterned features (shifters) formed on/in the substrate to phase-shift a radiation beam passing therethrough. In one embodiment, the shifters may include areas in which the substrate is partially etched such that the radiation beam through these areas has a predefined phase shift, such as about a 180 degree shift relative to areas not etched. In another embodiment, the shifters may be integrated with the absorption layer. For example, a MoSiON layer may be coated on the substrate to provide partial absorption and a phase shift to a radiation beam. However, MoSiON material is sensitive to base-containing solutions and can be damaged during a conventional cleaning process, resulting in further defects on the mask. The mask 200 may further include a pellicle 206 having a transparent membrane 206a and a frame 206b. The pellicle 206 is attached to and secured on the transparent substrate 202 to protect the substrate 202 from damage and contamination. The pellicle 206 may be attached to the substrate 206 by glue. When the mask 200 needs to be repaired during fabrication, the pellicle 206 may be detached, resulting in glue contamination to the mask. The disclosed method 100 may be applicable to the mask 200 with the pellicle 206 detached, or alternatively without the pellicle attached. The method 100 can be applied at different stages of a mask fabrication. In various embodiments, the method 100 may be implemented at a stage such as, before the formation of any patterned layer on the mask, after the formation of an absorption layer on the mask, after the patterning of an absorption layer on the mask, before the pellicle is attached to the mask, before a photoresist layer is formed on the mask, or after a photoresist layer is stripped from the mask.

The method 100 may include a step 112 to clean the mask using a chemical solution. At step 112, the mask is cleaned in a chemical cleaning procedure. In one embodiment, the mask is cleaned using a SC-1 cleaning solution. The SC-1 solution includes NH₄OH, H₂O₂, and H₂O. In one example, the SC-1 solution to be used may have a mixture of NH₄OH, H₂O₂, and H₂O with a relative volume of about 0 to 1, 2, and 100 to 600, respectively. The SC-1 solution may be maintained at a temperature ranging between about 50° C. and 150° C. during the chemical cleaning process. A megasonic wave may be applied to the SC-1 solution during the cleaning process. The chemical cleaning process may have a duration ranging between about 5 and 60 minutes.

The step 112 may include cleaning the mask using deionized water (DI water or DIW). The DI water cleaning process may be implemented in various modes including DI water shower, vapor, or dip. The DI water cleaning may be carried out with an additional mechanical force from an ultrasonic wave with proper frequency, power, and setup. The cleaning process may have a duration ranging between about 10 and 120 seconds.

The step 112 may further include a drying process in which the mask, after the above described chemical cleaning processes, is dried using isopropyl alcohol (IPA). IPA may be heated and maintained at a temperature ranging between about 50° C. and 150° C. The IPA drying process may have a duration between about 20 and 150 seconds. In one example, the mask is wetted by IPA vapor and then dried in air or an inert gas such as a nitrogen gas environment.

In another embodiment, other chemical solution may be additionally or alternatively used to clean the mask before the DI water cleaning process and/or before the drying process. For example, an acid solution may be added to the procedures of step 112 to clean the mask.

At step 114, a plasma treatment is applied to the mask to remove contaminants including particles and other residues strongly attached, chemically and/or physically, to the mask. In one embodiment, the plasma treatment uses argon to form argon ions. The argon ions can physically strike the mask surface to detach the contaminant particles, spots, and/or residues from the mask surface. In various other embodiments, the plasma treatment utilizes an element selected from oxygen, nitrogen, hydrogen, and combinations. Ions and/or radicals, such as O₂⁺⁺ and H⁺ are generated from oxygen, nitrogen and/or hydrogen and are applied to the mask to remove the contaminants. In one embodiment, the plasma treatment is performed in a vacuum environment. For example, the plasma treatment may have a pressure less than about 10⁻³ torr. In one embodiment, the plasma treatment is implemented in a suitable plasma module such as a reactive ion etching (RIE) system or the like. In another embodiment, the plasma treatment is implemented in an inductively coupled plasma (ICP) system or the like. In another embodiment, the plasma treatment is performed with additional gas injection such as the gas injection described below.

At step 116, the method 100 may further include a gas injection to and towards the mask to treat the mask surface and further remove various contaminants from the mask. The step 116 may use nitrogen, argon, or other inert gas to treat the mask with proper injection speed and force such that the contaminates can be efficiently detached from the mask.

The method 100 may further include a thermal process step 118 to heat the mask to a high temperature, ranging from about 150° C. to about 350° C., for example. The thermal step 118 may be implemented by a mechanism similar to a rapid thermal annealing (RTA), or other proper heating mechanism. For example, the thermal process may be carried out by a hot plate or a heat diffusion device. In one embodiment, the thermal process is performed in a vacuum environment. In another embodiment, the thermal process is combined with a gas injection such as the gas injection described at step 116. In this case, the efficiency of the gas injection in removing contaminants from the mask is enhanced by the thermal process. The temperature range of the thermal process can be larger while maintaining proper efficiency when the gas injection is implemented in parallel.

The method 100 also includes a step 120 to irradiate the mask (e.g., an irradiation treatment). In various embodiments, the irradiation treatment may use a laser irradiation treatment, and/or ultra-violet (UV) irradiation treatment. In one example, the irradiation treatment includes UV irradiation with a wavelength ranging between about 157 nm and about 257 nm. In another example, the irradiation treatment includes a treatment duration ranging from about 10 minutes to about 2 hours. In a further example, an 172-nm Osram lamp may be used for this purpose. The irradiation treatment may be performed in a vacuum environment such as a vacuum chamber. The vacuum chamber can be pumped to a pressure lower than 2*10⁻⁶ torr before applying the irradiation treatment. During the irradiation treatment, the mask is secured by a face-down chuck configured such that particle dropping to the mask or the chuck is prevented. In one exemplary experiment with about 2000 joules irradiation, chemical residue is decomposed and then removed. In another embodiment, the gas injection process is combined with the irradiation treatment such that both processes are implemented in parallel.

In various embodiments, the plasma treatment, the gas injection, the thermal treatment, and/or the irradiation treatment at various steps can be properly combined to achieve high efficiency, as noted above. For example, the gas injection can be implemented during the irradiation treatment. In another example, the gas injection can be implemented during the plasma treatment. In another example, the gas injection can be implemented during the thermal treatment.

In one embodiment, the method 100 includes a chemical cleaning process implemented after the plasma treatment. In another embodiment, after the plasma treatment, the gas injection, the thermal treatment, and/or the irradiation treatment are performed at various steps, a chemical cleaning process is applied to the mask. The chemical cleaning process may be substantially similar to the chemical cleaning process described at the step 112. For example, the chemical cleaning process may utilize a SC-1 cleaning solution. The SC-1 solution includes NH₄OH, H₂O₂, and H₂O. In one example, the SC-1 solution has a mixture of NH₄OH, H₂O₂, and H₂O with a relative volume of about 0 to 1, 2, and 100 to 600, respectively. During the chemical cleaning process, the SC-1 solution may be maintained at a higher temperature, such as a temperature ranging between about 50° C. and 150° C. A megasonic wave may additionally be applied to the SC-1 solution during the cleaning process. The chemical cleaning process has a duration ranging between about 5 and 60 minutes in one example.

In another embodiment, the chemical cleaning process includes cleaning the mask using DI water. The DI water cleaning process may be implemented in various modes including DI water shower, vapor, or dip. The DI water cleaning may be carried out with an additional agitation from an ultrasonic wave with proper frequency, power, and setup. The DI water cleaning process may have a duration ranging between about 10 and 120 seconds.

In another embodiment, the chemical cleaning process includes a drying process. The mask is thereafter dried using IPA. IPA may be heated and maintained at a temperature ranging between about 50° C. and 150° C. The IPA drying process may have a duration between about 20 and 150 seconds. In one example, the mask is wetted by IPA vapor and then dried in air or an inert gas such as a nitrogen gas environment.

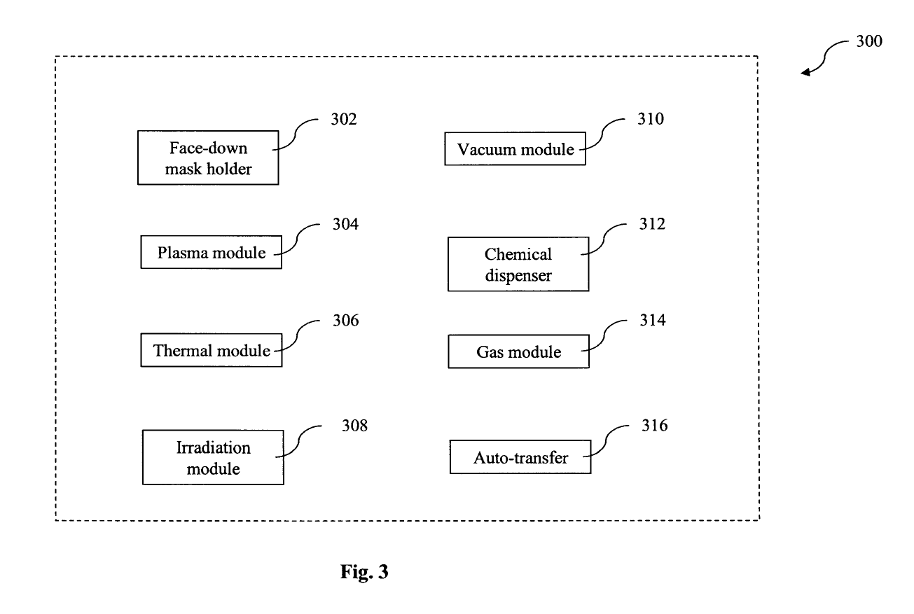

FIG. 3 is a block diagram illustrating an exemplary system 300 designed to implement the mask cleaning method 100 of FIG. 1. The system 300 includes a mask table 302 which may to secure a mask in a configuration such that the patterned mask surface is face-down preventing particle re-deposition to the mask and or the mask table. In one embodiment, the system 300 includes more than one mask holder integrated with various modules of the system. The mask can be transferred among the various modules and secured by a mask holder embedded in each module to perform a proper cleaning process in each module.

The system 300 also includes a plasma module 304 designed and configured to provide plasma to the mask such that the mask contaminants can be effectively removed. The plasma module 304 is capable of generating ions and/or radicals of argon, oxygen, nitrogen and/or hydrogen and directing the generated ions/radicals to the mask. In one embodiment, the plasma module includes a selected gas inlet, a radio frequency (RF) power system and a vacuum chamber integrated to provide a plasma environment. The plasma environment may achieve mask surface conditioning in one example. In one embodiment, the plasma module include a reactive ion etching RIE system or the like. In another embodiment, the plasma module includes an inductively coupled plasma system or the like. In another embodiment, the plasma module includes a plasma chamber designed to be pumped down to a pressure lower than about 10⁻³ torr. In another embodiment, the plasma chamber is integrated a gas injection unit such that a gas such as argon or nitrogen can be injected to the mask in the plasma chamber during the plasma treatment.

The system 300 includes a thermal module 306 designed to heat the mask to a higher temperature. In one embodiment, the thermal module 306 may include heating structure similar to an RTA tool. In another embodiment, the thermal module 306 includes a hot plate. In another embodiment, the thermal module includes a heat diffusion device or the like. The thermal module may further include thermal sensors configured for temperature control.

The system 300 includes an irradiation module 308 designed to perform an irradiation treatment on the mask. In one embodiment, the irradiation module may include a laser to provide a laser treatment. In another embodiment, the irradiation module may include a UV lamp to provide a UV irradiation treatment. In one example, the irradiation module includes a UV lamp capable of generating UV irradiation with a wavelength ranging between about 157 nm and about 257 nm. In a further example, the irradiation module includes an 172-nm Osram lamp. The irradiation module may further include a chamber to provide a vacuum environment. The vacuum chamber is designed to be pumped to a pressure lower than 2*10⁻⁶ torr. In another example, the irradiation unit, such as a laser or an UV lamp, is integrated with the vacuum chamber. For example, a laser or a UV lamp is built in the vacuum chamber for the irradiation treatment in a vacuum environment. In another embodiment, an gas injection unit is integrated into the irradiation module to perform the irradiation treatment with gas injection provided to the mask in parallel.

The system 300 may additionally include a vacuum module 310. For example, the system 300 includes a vacuum chamber. In another embodiment, the system 300 includes various vacuum devices capable of providing a vacuum environment with a pressure lower than 10⁻³ torr. In another embodiment, the vacuum module may be designed and configured to provide a vacuum environment to various modules such as the plasma module 304, the thermal module 306, and/or the irradiation module 308.

The system 300 includes a chemical dispenser 312 designed and configured such that various chemicals can be dispensed, blended at a predefined ratio, and sent to a cleaning location such as a cleaning tank, a cleaning chamber or other suitable configuration. In this case, the cleaning tank or cleaning chamber may be also integrated with the chemical dispenser or combined with other proper modules. In one example, the chemical dispenser 312 is designed to controllably dispense NH₄OH, H₂O₂, IPA, and DI water.

The system 300 includes a gas injection module 314 designed to inject a gas including argon or nitrogen. The gas injection module 314 can be configured such that the injected gas can be effectively provided to other modules such as plasma module 304, thermal module 306, and/or the irradiation module 308.

The system 300 may further include an auto-transfer 316 such as a robotic hand to automatically transfer a work piece (such as a mask) among the various module. In one example, the mask in a pod can be automatically transferred to a vacuum chamber. The system 300 may further include other proper modules integral to various components of the system 300. For example, the system 300 includes an ultrasonic source to provide ultrasonic energy to various chemical fluids to provide mechanical cleaning. The ultrasonic source can provide ultrasonic energy with various frequencies and an adjustable power level. For example, the ultrasonic source may provide an ultrasonic power having a frequency of about 360 KHz and/or a megasonic power having a frequency of about 1 MHz. The ultrasonic power is generated thereby and transferred to a cleaning fluid such as DI water or SC-1 solution. The system 300 may include other components such as a power supply, electrical control, operator interface, and/or a cleaning chamber configured to implement the method 100 for effective cleaning of a mask such as a phase shift mask.

The present disclosure provides a method and a system to clean a mask to reduce chemical contaminants. Various embodiments, alternatives and extensions may be additionally or alternatively implemented according to aspects of the disclosure without departure from the spirit and scope thereof. For example, more than one mask can be processed in a batch by the method 100, with proper configurations for batch cleaning. In the method 100, various steps can be combined, implemented in parallel, or performed in different sequence to effectively reduce chemical contaminants. In the system 300, each module can be combined with, distributed in, embedded in and/or integrated with other modules or an additional subsystem in various configurations such that the method 100 can be implemented more efficiently. For example, a special wavelength scan system can be embedded in a vacuum chamber to provide better pumping capability and higher efficiency of breaking chemical bonds between the mask and the contaminants. In another example, a special hot baking system can be embedded in a vacuum chamber to provide better residue outgassing efficiency and pumping capability. In other examples, the chemical cleaning process at step 112 may be skipped, performed at different stage such as after the plasma treatment, and/or repeated at different stages. In one example, the method 100 can be implemented at various mask fabrication stages such as after a photoresist layer is stripped, or cleaned. In another example, the method 100 is implemented after a mask final cleaning step and before a pellicle is mounted. In another embodiment, the system 300 is integrated with other mask making tools such as photolithography tools, deposition tools, etching tools, and/or e-beam tools for fabrication efficiency and reduced contamination sources. The mask thus cleaned may be further inspected for any remaining contamination and/or damage. The method 100 may be repeated if necessary.

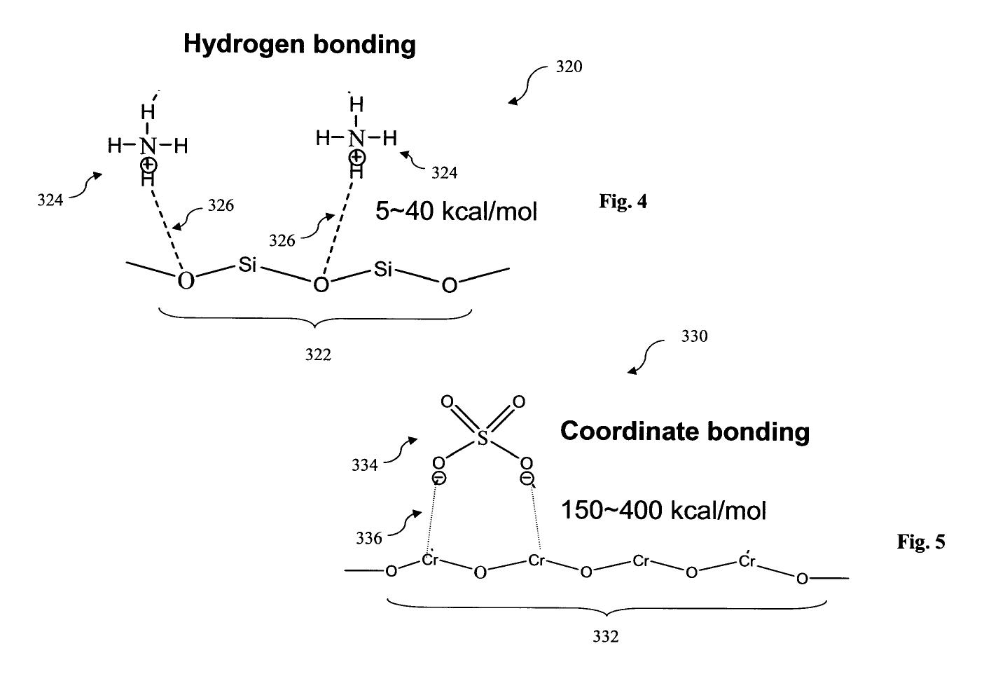

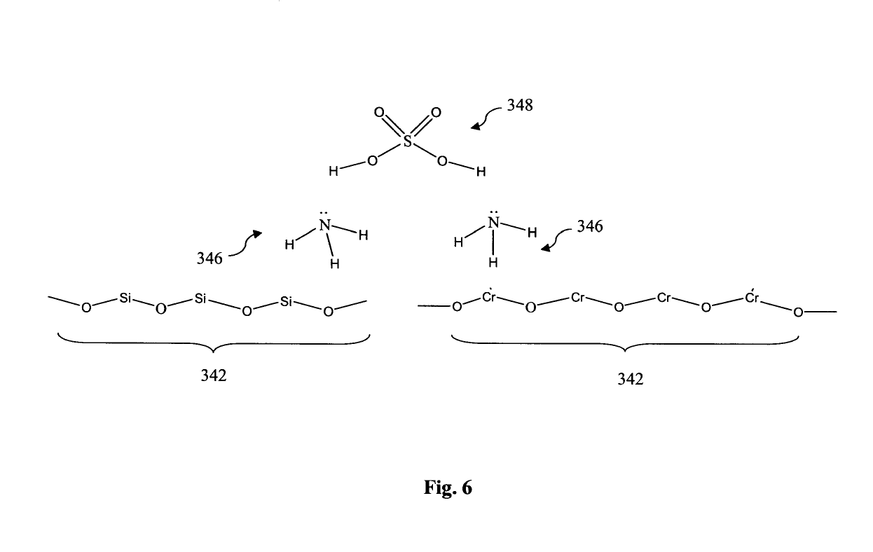

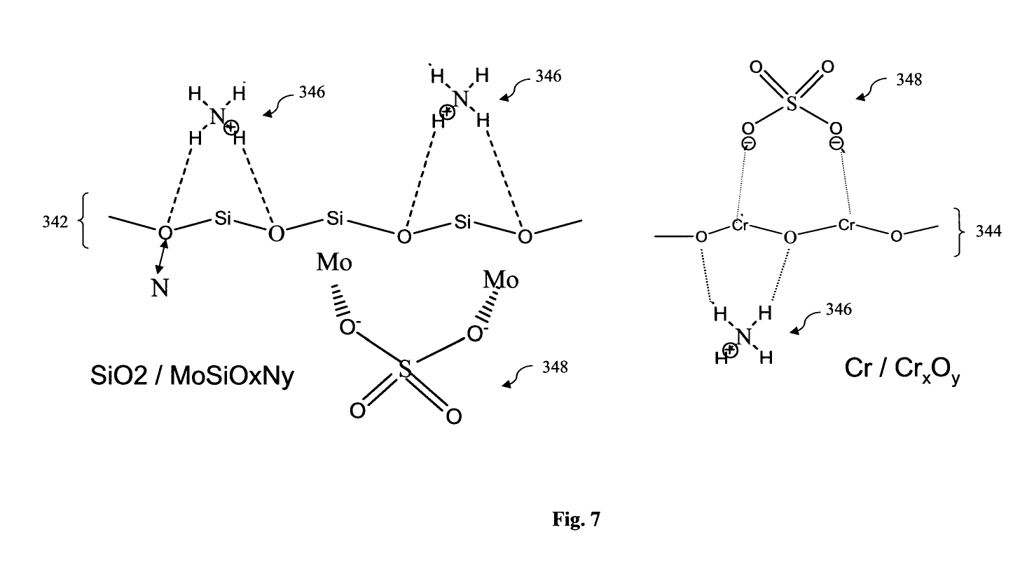

The present disclosed method provides method and a system to reduce various chemical residues with different chemical bonding strengths. For example, FIG. 4 illustrates a schematic diagram of a chemical bonding between a glass substrate 322 and a chemical residue 324 such as an ammonia. In this situation, the bonding is a hydrogen bonding 326 that may have a bonding energy ranging between about 5 and about 40 kcal/mol. For another example, FIG. 5 illustrates a schematic diagram of a chemical bonding between a Cr coated substrate 332 and a chemical residue 334 such as a sulfate. In this situation, the bonding is a coordinate bonding 336 that may have a bonding energy ranging between about 150 and about 400 kcal/mol. FIGS. 6 and 7 are schematic diagrams illustrating mask surface chemical reduction. A to-be-treated mask may include various mask surfaces such as, a first mask substrate 342 including a glass substrate or a MoSiON coated substrate, or a second mask substrate 344 including a Cr coated substrate or a CrO coated substrate. Various chemical residues such as ammonia 346 and sulfate 348 can be removed from the above mask surfaces by implementing various embodiments of the disclosed method. For example, the UV irradiation in a vacuum environment can effectively break the above described hydrogen bonds and coordinate bonds to remove the ammonia and sulfate chemical residues. The disclosed method provides an efficient cleaning procedure. The method can be used to clean other types of masks and other suitable substrates.

Thus, the present disclosure provides a method for mask chemical residue reduction. The method includes forming an absorption material layer on a mask; applying a plasma treatment to the mask to reduce chemical contaminants after the forming of the absorption material layer; performing a chemical cleaning process to the mask; and performing a gas injection to the mask.

In the disclosed method, the forming of the absorption layer may include forming a material layer having at least one of Cr and MoSi. The forming of the absorption layer may include patterning the absorption layer. The method may further include applying an irradiation treatment to the mask. Applying of the irradiation treatment may include applying at least one of an ultra violet irradiation (UV) and a laser. The method may further include heating the mask to a temperature ranging between about 150° C. and 350° C. The applying of the plasma treatment may include utilizing a plasma element selected from the group consisting of oxygen, argon, nitrogen, and hydrogen. The performing of the gas injection may include utilizing a gas selected from the group consisting of nitrogen, argon, and combinations thereof. The applying of the plasma treatment may be implemented before mounting a pellicle to the mask. The applying of the plasma treatment may be implemented when the mask has no photoresist layer on the mask. The method may further include holding the mask by a mask holder configured such that a mask surface to be treated is facedown. The performing of the chemical cleaning process may include applying a solution of NH₄OH, H₂O₂, and H₂O.

The present disclosure also provides a system for mask chemical residue reduction. The system includes a mask table configured for holding a mask in a facedown mode; a chemical dispenser designed for providing cleaning chemicals to clean the mask; a plasma module designed for performing a plasma treatment to the mask to remove contaminants from the mask; and a temperature control module configured to control mask temperature.

In various embodiments, the disclosed system may further include an irradiation module designed for providing an irradiation treatment of the mask. The system may further include a gas module configured to inject a gas to the mask.

The present disclosure also provides a method including performing a chemical cleaning process of a mask; performing a plasma treatment of the mask; and performing an irradiation treatment of the mask.

In the disclosed method, the performing of the plasma treatment may include implementing the plasma treatment at a raised temperature ranging between about 150° C. and about 350° C. The performing of the plasma treatment may further include providing a vacuum environment to the mask. The method may further include applying a thermal process to the mask in a vacuum environment. The performing of the irradiation treatment may include implementing the irradiation treatment during the performing of the plasma treatment.

While the preceding description shows and describes one or more embodiments, it will be understood by those skilled in the art that various changes in form and detail may be made therein without departing from the spirit and scope of the present disclosure. For example, various steps of the described methods may be executed in a different order or executed sequentially, combined, further divided, replaced with alternate steps, or removed entirely. In addition, various functions illustrated in the methods or described elsewhere in the disclosure may be combined to provide additional and/or alternate functions. Therefore, the claims should be interpreted in a broad manner, consistent with the present disclosure.

What is claimed is:

1. A method, comprising:
forming an absorption material layer on a mask;
applying a plasma treatment to the mask to reduce chemical contaminants after the forming of the absorption material layer;
performing a chemical cleaning process to the mask; and
performing a gas injection to the mask.

2. The method of claim 1, wherein the forming of the absorption layer includes forming a material layer having at least one of Cr and MoSi.

3. The method of claim 1, wherein the forming of the absorption layer comprises patterning the absorption layer.

4. The method of claim 1, further comprising applying an irradiation treatment to the mask in a vacuum environment.

5. The method of claim 4, wherein the applying of the irradiation treatment comprises applying at least one of an ultra violet irradiation (UV) and a laser.

6. The method of claim 1, further comprising heating the mask to a temperature ranging between about 150° C. and 350° C.

7. The method of claim 1, wherein the applying of the plasma treatment comprises utilizing a plasma element selected from the group consisting of oxygen, argon, nitrogen, and hydrogen.

8. The method of claim 1, wherein the performing of the gas injection comprises utilizing a gas selected from the group consisting of nitrogen, argon, and combinations thereof.

9. The method of claim 1, wherein the applying of the plasma treatment is implemented before mounting a pellicle to the mask.

10. The method of claim 1, wherein the applying of the plasma treatment is implemented when the mask has no photoresist layer on the mask.

11. The method of claim 1, further comprising holding the mask by a mask holder configured such that a mask surface to be treated is facedown.

12. The method of claim 1, wherein the performing of the chemical cleaning process includes applying a solution of NH₄OH, H₂O₂, and H₂O.

13. A system, comprising:
a mask table configured for holding a mask in a facedown mode;
a chemical dispenser designed for providing cleaning chemicals to clean the mask;
a plasma module designed for performing a plasma treatment to the mask to remove contamination; and
a temperature control module configured to control mask temperature.

14. The system of claim 13, further comprising an irradiation module designed for providing an irradiation treatment to the mask.

15. The system of claim 13, further comprising a gas module configured to inject a gas to the mask.

16. A method, comprising:
performing a chemical cleaning process of a mask;
performing a plasma treatment to the mask; and
performing an irradiation treatment to the mask.

17. The method of claim 16, wherein the performing of the plasma treatment comprises implementing the plasma treatment at a raised temperature ranging between about 150° C. and about 350° C.

18. The method of claim 16, wherein the performing of the plasma treatment further comprises providing a vacuum environment to the mask.

19. The method of claim 16, further comprising applying a thermal process to the mask in a vacuum environment.

20. The method of claim 16, wherein the performing of the irradiation treatment comprises implementing the irradiation treatment during the performing of the plasma treatment.
